(19) United States
(12) Patent Application Publication
(10) Pub. No.: US 2004/0151950 A1
(43) Pub. Date: Aug. 5, 2004

(54) Nickel-based concrete stain, method of applying same, and stained concrete

(75) Inventor: Larry E. Good, Lexington, SC (US)

Correspondence Address: Nail C. Jones, Nelson Mullins Riley & Scarborough LLP, Keenan Building, Third Floor, 1330 Lady Street, Columbia, SC, 29201, US

(73) Assignee: Specialty Concrete Products

(21) Appl. No.: 10/357,302

(22) Filed: Feb. 3, 2003

(51) Int. Cl. B32B 9/00

(52) U.S. Cl. 428/703; 428/472

(57) ABSTRACT

The present invention is an alternative to currently employed copper-based concrete and masonry stains by providing nickel salts to produce a concrete stain that demonstrates improved characteristics over the copper-based stains. Unlike known copper-based stains, the present nickel-based stains do not blacken or darken as readily as copper-based stains.

### FIELD OF THE INVENTION

The present invention relates to compositions utilized to stain concrete, masonry, rock, stone and various cementious substrates. In particular, the present invention relates to a nickel-based concrete stain and method for applying a nickel-based concrete stain to decoratively color masonry, concrete, or other cementious surfaces.

### BACKGROUND OF THE INVENTION

Concrete and like materials are produced from the alkaline earth metals. Concrete is produced by mixing Portland, or similar hydraulic cements, with sand, gravel, and water. As the water reacts with the cement, it forms hydrates with the various complex calcium compounds in the cement and the mixture then hardens into solid material. The various complex calcareous hydrates in the mixture are insoluble in water but react readily with most acids.

Stains, pigments, and intrinsic additives have been employed to decoratively stain concrete, masonry and other cementious surfaces for several years. The vast majority of decorative stains available and commercially known in the prior art have been composed of pigments or stains, along with some type of applicable carrier base such as water or solvent. These types of stains are commonly used on masonry, concrete and similar surfaces. For example, an antique effect is established on such surfaces by using suitable colors applied to simulate the qualities and/or overall aesthetic appearance desired. A variation of color tone may be accomplished from applications of pigmented washes. Such appearances are common throughout the Mediterranean regions of the world and are now widely imitated architectural coatings. In the aforementioned prior art stain applications, the colors most commonly employed are known as the earth tones, including terra cotta tints and others.

Conventional painting and staining techniques may provide a single tone or color over a masonry or like surface. In order to arrive at an antique or washed effect, numerous applications of shaded and/or color pigments may be applied until the desired effect is attained. When prior art pigments, stains, and the like are conventionally applied to an exposed masonry surface, it is difficult to create an appropriate appearance.

Certain new concrete compositions utilize an intrinsic color mixed into the cement to change the permanent color of the cement. However, in order to accomplish this, a coloring agent is mixed with the concrete blend. While such coloring agents function to change the color of the concrete, a thorough clean-up of the applicator equipment is necessary due to the presence of the coloring agent, resulting in considerable labor and expense.

In addition, polymer-based paints, such as pigmented acrylic latexes, have also been used to stain or paint concrete. However, while concrete floor paints form a protective coating on the surface of the concrete, stains actually penetrate the surface to produce a superior bond that resists peeling & flaking.

Conventional acid-based stains have been employed for many years and come in a premixed, ready-to-use format with a limited color range. These decorative stains or coating compositions can be applied using conventional, low-cost techniques to exposed masonry, concrete or like material surfaces in order to provide an aesthetically attractive appearance to such surfaces. An acid-based stain gives concrete a variegated look that is unique in that no two acid-stained surfaces are ever alike. They can be used to create soft, earth tone color shades on concrete surfaces similar to the effects of tiles, marble and patinas. Acid staining is ideal for interior concrete floors because they are easy to clean and require little maintenance when properly sealed and waxed. Oftentimes, acid staining is a cost effective alternative to more expensive flooring materials such as hardwood floors, tiles and carpet.

Such stains are effective at enhancing the appearance of these materials without the necessity of expensive and laborious pre-treatment, such as cleaning and restoration. One particular architectural acid-stain includes an iron-based composition that provides a natural patina to such surfaces. The use of the iron-based composition for staining results in a stain that is easier to maintain than other paints and stains.

A particular advantage of such stains is that they are permanent. As mentioned above, when applied properly, such stains and/or coatings do not wash, peel or leech off the applied surfaces.

Current concrete stains typically use divalent salts of iron (iron chloride or iron sulfate) to produce reddish colors; copper salts (such as cupric chloride) to produce greenish colors; and manganese salts to produce the darker brown or black colors. Hydrates of these salts are dissolved in water and then mixed with hydrochloric acid (also known as muriatic acid in the concrete industry). Sodium bichromate may sometimes be added as a color modifier to darken the iron and manganese stains and to turn the blue-green color of cupric chloride to a lighter green shade.

A problem currently exists with many of the stains and, particularly, the copper-based stains. The copper-based stained concrete will often develop black or brown spots after a sealant has been applied to the stained concrete. These spots are apparently dark oxides of copper formed by the presence of free water that is trapped in the concrete by the applied sealer before the concrete is sufficiently cured.

Most manufacturers recommend that concrete be allowed to cure at least four weeks after pouring so as to release the water in the concrete, either by hydration of the cement or by evaporation into the atmosphere. Even when allowing extensive time for curing, some copper-based stains will still show dark spots after staining and sealing.

It would be desirable to reduce the amount of spotting in stained concrete. In addition, it would be desirable to be able to stain concrete within a day or so after it is poured, rather than having to allow the concrete to cure for four or five weeks. It is to these and other aims that the present invention is directed.

### SUMMARY OF THE INVENTION

The present invention provides an alternative to currently employed copper-based concrete and masonry stains. In particular, the present invention employs nickel salts to produce an attractive green stain that demonstrates improved characteristics over the copper-based stains. Unlike known copper-based stains, the present nickel-based stains do not blacken or darken as readily as copper-based stains. In fact, by employing the present nickel-based stains, staining of the concrete can occur only a few days after the concrete is poured.

The nickel-based, acid-applied, chemical formulations utilized in the present process are enabled, through a chemical reaction after application, concrete, masonry, stone, and like materials to be colored to greatly enhance the overall aesthetic appearance of the structure.

More specifically, the invention employs a nickel-based stain solution composed of a nickel salt solution (such as nickel chloride, nickel nitrate, nickel acetate, or nickel phosphate) and muriatic acid. The ratio of nickel salt solution to muriatic acid is roughly about 12 to 1 by volume, but other ratios may be utilized.

The stain is then applied to concrete or other like surface in conventional staining manners to create a lasting, aesthetically pleasing appearance.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention, which broader aspects are embodied in the exemplary constructions.

The present invention, which is an alternative to currently employed copper-based and other concrete and masonry stains, uses nickel salt solutions in combination with acids, such as muriatic acid, to produce an attractive green stain that demonstrates improved characteristics over the copper-based stains. Unlike known copper-based stains, the present nickel-based stains do not blacken or darken as readily as copper-based stains. In fact, by employing the present nickel-based stains, staining of the concrete can occur only a day or two after the concrete is poured.

More specifically, the invention employs a nickel-based stain solution composed of a nickel salt solution (such as nickel chloride, nickel nitrate, nickel acetate, or nickel phosphate) and an acid such as muriatic acid. The ratio of nickel salt solution to muriatic acid in one embodiment is roughly about 12 to 1 by volume. The stain is then applied to concrete or other like surface in conventional staining manners.

Various nickel-based salts may be used as the stain. For example, nickel acetate, nickel phosphate, nickel nitrate, and nickel chloride may be employed. Other nickel-based salts may also be used. In one particular embodiment, one gallon of a 14% solution of nickel chloride solution may be mixed with 11 fluid ounces of 20 degree Baume′ hydrochloric acid so as to achieve approximately a 12:1 volume ratio of nickel solution to muriatic acid.

As suggested above, acid stain is not a paint or a coating agent but is rather solution that causes a chemical reaction on a cementious material. Acid stains can be applied to any concrete, polymer overlay, or self-leveling products that have a cementious base, such as cement-based interior or exterior floors, countertops, and walls. The stain solutions are made with water, acid and inorganic salts and react with minerals present in the concrete, resulting in coloring of the concrete.

Not every concrete structure provides a suitable surface for acid staining. For example, a smooth concrete surface will often yield more attractive results than an old worn one. If the concrete is contaminated, the aggregate is exposed, or the concrete has previously been acid etched, the stain may not “take in” and will not look as desired. The aggregate material in the cement does not react with the stain, only materials in the concrete paste do. In other applications, and in particular where the surface is textured, as in stamped concrete or stamped overlays, acid staining provides depth of color, larger selection of styles, and a realistic look to the surface.

In order to apply acid stains such as the present invention, the concrete surface should be clean and free from dirt, grease, paint, water repellants such as sealers, and curing agents. Such foreign agents may prevent the stain from penetrating and reacting. One cleaner for concrete surfaces that allows proper preparation prior to acid staining is trisodium phosphate-containing cleaners. In addition, it may be desirable to chip or scar the concrete surfaces before they are stained so as to create an “aged” appearance.

Unlike known stains, the present inventive stain can be applied to a concrete surface before it is completely cured. Manufacturers of previously-known acid stains typically recommend that the concrete surface be cured for at least 14 to 28 or even more days to allow sufficient time to achieve a complete cure prior to staining.

Acid stains such as the present invention can be applied using known techniques. Typically, acid staining a concrete surface involves very few tools. The stain can be applied with tools such as sprayers, brushes, and brooms. A saw with a diamond blade or a stencil sand blaster may be used for scoring the surface or creating various designs in the surface after staining. Such tools allow one to cut in simple designs or very sophisticated mosaics. The manner in which the stain is applied will determine, to a certain extent, the look achieved after the application.

Typically, one gallon of acid stain will stain approximately 150 to 200 square feet of surface. After applying the acid stain and allowing it to dry, the acid must then be neutralized. This is typically done by employing a basic powder such as baking soda (typically 0.5 lbs baking soda/five gallons of water) or a solution of ammonia (typically one quart ammonia/five galls of water). The baking soda or ammonia may be applied to the surface, brushed over the surface to ensure contact with the free acid solutions, and then removed by rinsing with water. The surface, particularly if it is a floor, may then be sealed and or waxed to protect the stain and add shine and depth.

### EXAMPLES

The following examples describe various embodiments of the invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples.

### EXAMPLE 1

A concrete slab was poured on a grade from ready-mix concrete. The slab was 4″ thick, and measured 4 foot by 5 foot. The day after the slab was poured, half of one end of the slab was stained with a nickel-based concrete stain (containing 1 gallon of 14% nickel chloride and 10 fluid ounces of muriatic acid). The other end of the slab was stained with a known copper-based stain and muriatic acid. The copper-based stain was made from cupric chloride.

After staining, the stained end slab of concrete was neutralized with ammonia and dried. The stained portion of the slab was then sealed.

The next day, the portion of the slab stained with the copper-based stain exhibited slight discoloration but the nickel-based stain showed only minor, localized darkening. On day 4 after staining, the copper-based stain showed signs of extensive black darkening while the nickel-based stain continued to exhibit only localized slight darkening. On day 4, the unstained end of the slab was sanded, water washed, dried, and stained as above with the copper-based acid stain on one side and the nickel based stain on the other. This left two corners of the slab stained with each of the copper and nickel based stains; one nickel/copper pair stained 4 days after the other.

Two days after staining the other end (day 6 after the original staining), the latter copper-stained corner of the slab was almost completely discolored in black. The nickel-based corner of the latter stained end of the slab showed no discoloration.

On day 27 after the staining, the both copper-based stained corners of the slab were completely black. The portions stained with the nickel-based stain exhibited no additional discoloration.

### EXAMPLE 2

A slab of concrete was formed and stained with the nickel-based stain described above in Example 1. Another slab of concrete was formed and stained on the same day with a conventional copper-based stain and muriatic acid. Both slabs were then neutralized with a solution of 10% ammonia (5% household ammonia), dried with a space heater, and then sealed with two coats of conventional 30% sealer (Chrome-Seal™ 30% Solids Clear Sealer available from Specialty concrete Products, inc. of West Columbia, S.C.). The sealed slabs were then dried overnight with the space heater.

On day 1 after staining, the slab stained with the conventional copper-based stain exhibited very slight darkening in spots but the slab stained with the nickel-based stain exhibited no discoloration. The slabs were then placed outdoors.

On day 2 after staining, the slab stained with the conventional copper-based stain exhibited noticeably more darkening but the slab stained with the nickel-based stain continued to exhibit no discoloration.

On day 6 after staining, the slab stained with the conventional copper-based stain was mostly black except around the edges and there was no discoloration of the nickel-based stained slab.

On day 10 after staining, the copper-based stained slab was almost entirely black except for the edges and there still was no discoloration of the nickel-based stained slab.

### EXAMPLE 3

About 40% of the smooth side of a concrete slab was stained with the nickel-based acid stain described above in Example 1. Another approximately 40% of the smooth side of the slab was stained with a conventional copper-based (cupric chloride) acid stain and muriatic acid. The slab was stained so that an approximately 1-inch thick unstained strip of concrete remained between the two portions. The stained portions were then sealed with two coats of the sealer described above in Example 2.

Three days after staining, the copper-based stained side exhibited several small black spots while the nickel-based stained side showed no discoloration. On day 7, the copper-based side exhibited several black spots of up to 0.25″ in diameter while the nickel-based stained side continued to show no discoloration. On day 10, the copper-based side had more and larger (approximately up to 0.375″ in diameter) black spotting while the nickel-based stained side continued to show no discoloration. On day 17, the black spots on the copper-based side continued to grow up to 0.50″ in diameter and became darker while the nickel-based stained side continued to show no discoloration.

### EXAMPLES 4-6

Acid stains were formed from other nickel-based salts and all were tested for colorfastness. Each of the tested nickel-based salts performed adequately after sealing with little or no discoloration and little or no cure time on the concrete slab.

One such stain (Example 4) was comprised of nickel acetate having a pH of from about 4 to about 5; another stain (Example 5) was comprised of nickel phosphate having a pH of less than about 1; and the third stain (Example 6) was comprised of nickel nitrate having a pH of from about 1 to about 4. Each of the stains was applied in combination with their related acids to concrete. The nitrate was combined with nitric acid; the phosphate was combined with phosphoric acid; and the acetate was combined with acetic acid.

It is to be understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

What is claimed is:

1. An acid stain for staining concrete and other cementious materials, said stain comprising a nickel salt.

2. The acid stain of claim 1 wherein said nickel salt is chosen from the group consisting of nickel chloride, nickel acetate, nickel phosphate, and nickel nitrate.

3. The acid stain of claim 1 further comprising muriatic acid.

4. The acid stain of claim 3 wherein said stain comprises nickel chloride and muriatic acid.

5. An acid stain for staining concrete and other cementious materials, said stain consisting essentially of a nickel salt and an acid.

6. The acid stain of claim 5 wherein said nickel salt is chosen from the group consisting of nickel chloride, nickel acetate, nickel phosphate, and nickel nitrate and said acid is muriatic acid.

7. A method of staining concrete and other cementious material comprising the steps of:
a) ensuring that the surface of said material is free from dust, oil, and other contaminants that would affect stain bonding;
b) applying an acid stain to the surface of said concrete, said acid stain comprising a nickel-based solution and an acid;
c) spreading said acid stain on the surface of said surface so that the desired coverage is achieved;
d) drying said acid-stained material surface to result in an acid-stained concrete or cementious surface.

8. The method of claim 7 further comprising applying a sealer to the material surface after applying the acid stain.

9. The method of claim 7 wherein said nickel-based solution comprising a nickel salt chosen from the group consisting of nickel phosphate, nickel acetate, nickel chloride, and nickel nitrate.

10. A concrete material having a nickel based acid stained surface.

11. The concrete material of claim 10 wherein said material has been acid stained with a nickel-based solution comprising a nickel salt chosen from the group consisting of nickel phosphate, nickel acetate, nickel chloride, and nickel nitrate.
